(19) United States
(12) Patent Application Publication
(10) Pub. No.: US 2012/0078437 A1
(43) Pub. Date: Mar. 29, 2012

(54) METHOD AND REGULATING APPARATUS FOR REGULATING A TEMPERATURE OF AN ENERGY ACCUMULATOR UNIT

(76) Inventors: Matthias STRIPF, Karlsruhe (DE); Manuel WEHOWSKI, Stuttgart (DE)

(21) Appl. No.: 13/245,509

(22) Filed: Sep. 26, 2011

Related U.S. Application Data
(63) Continuation of application No. PCT/EP2010/053706, filed on Mar. 22, 2010.

(30) Foreign Application Priority Data
Mar. 25, 2009 (DE) 10 2009 014 300.9

(51) Int. Cl. G05D 23/00

(52) U.S. Cl. 700/300

(57) ABSTRACT

A method for regulating a temperature of an energy accumulator unit is provided, which is in thermal contact with at least one cooling unit. The method has a step of determining a temperature difference between a temperature at a primary measuring site of the energy accumulator unit and a temperature at a secondary measuring site of the energy accumulator unit or cooling unit. The method has a step of selecting a control variable using the determined temperature difference and a predefined characteristic curve, the predefined characteristic curve representing a correlation between a control variable and a temperature difference or a variable dependent thereon. An actuator is actuated via a regulating unit using the selected control variable for regulating a flow of the cooling and/or refrigerating agent through the cooling unit in order to bring about the regulation of the temperature of the energy accumulator unit.

This nonprovisional application is a continuation of International Application No. PCT/EP2010/053706, which was filed on Mar. 22, 2010, and which claims priority to German Patent Application No. DE 10 2009 014 300.9, which was filed in Germany on Mar. 25, 2009, and which are both herein incorporated by reference.

### BACKGROUND OF THE INVENTION

1. Field of the Invention

The present invention relates to a method and a regulating apparatus for regulating a temperature of an energy accumulator unit.

2. Description of the Background Art

Modern, high-performance batteries which are composed of a number of individual cells, for example, accumulators or secondary batteries, are being used with greater frequency in electric or hybrid vehicles, for example. In such cases, is important to ensure that the temperature of the battery stays within a certain range during operation, to guarantee the efficiency, functionality and safety of the device. In this regard, there are various problems that must be overcome.

For one, the efficiency of a battery cell or of an energy accumulator unit decreases radically when the temperature drops below a suitable operating temperature, and the cells produce high power losses. For another, above a suitable operating range, processes run within the cells that lead to irreversible damage. Moreover, to avoid a non-uniform and therefore intensified aging of individual battery cells, the temperature differences within the individual cells and in the entire battery stack cannot be allowed to exceed certain threshold limits.

For cooling batteries, a cooling medium is preferably conducted through cooling channels, which are in thermal contact with the battery. Refrigerating agent, preferably taken from the air conditioning system, or a cooling agent can be used as the cooling medium, for example. Because the load on the battery cell, and therefore heat losses during operation, can change significantly, the cooling device must be equipped with a suitable regulating apparatus.

Document DE 103 46 706 B4 discloses a method for regulating a battery, wherein the focus is on calculating the maximum temperature within the battery cell. On the basis of the measurement of at least one variable from which the power loss from the battery is determined, the temperature distribution within the battery cell is calculated and a prediction of the development of the temperature over time is made. Cooling is regulated on the basis of the maximum allowable temperature.

DE 3401 100 A1, which corresponds to U.S. Pat. No. 4,585,709, describes controlling the temperature inside a metal halogen battery. In this document, the battery temperature during the charging process is controlled on the basis of the optimum temperature for hydrate formation. This is accomplished by measuring a temperature outside the battery cell, which is used to determine the temperature inside the cell.

Document DE 102 02 807 A1 describes a system for controlling the temperature of high-performance secondary batteries. In this case, regulation is accomplished by measuring the temperature inside the battery housing.

The disclosure of DE 91 05 260 U1 describes a temperature controllable battery pack for powering a vehicle. The temperature is regulated by measuring the temperature of the temperature control medium at the output of the battery, and adjusting the pump system accordingly.

Document DE 10 2006 005 176 A1, which corresponds to U.S. Publication No. 20070204984, describes a cooling circuit and a method for cooling a fuel cell stack. The temperature of the fuel cell stack is regulated by measuring the intake and outlet temperatures of the cooling agent and adjusting the volume or temperature of the cooling agent.

All known temperature control devices for batteries regulate the temperature according to the measured or calculated cell temperature. They do not include optimized cooling over the lifespan of the battery.

### SUMMARY OF THE INVENTION

It is therefore an object of the present invention to provide a method for regulating the temperature of an energy accumulator unit and a regulating apparatus for implementing said method.

The present invention provides a method for regulating a temperature of an energy accumulator unit, wherein the energy accumulator unit is in thermal contact with a cooling unit through which a cooling and/or refrigerating agent flows, wherein the method comprises the following steps: determining a temperature difference between a temperature at a primary measuring site of the energy accumulator unit and a temperature at a secondary measuring site of the energy accumulator unit; selecting a control variable using the determined temperature difference and a predefined characteristic curve, wherein the predefined characteristic curve represents a correlation between a control variable and a temperature difference, or a variable that is dependent thereon; and actuating a control element by way of a regulating unit using the selected control variable in order to regulate the flow of the cooling and/or refrigerating agent through the cooling unit, and thereby regulate the temperature of the energy accumulator unit.

The present invention further provides a regulating apparatus, which is embodied for carrying out and/or actuating the steps of the aforementioned method.

In addition, the present invention provides a computer program with a program code for carrying out and/or actuating the steps of the aforementioned method, when the computer program is executed in a control device or a data processing system.

The present invention is based upon the knowledge that both the lifespan and the efficiency of an energy accumulator unit can be increased significantly if the temperature control of an energy accumulator unit is regulated with a targeted utilization of the thermal capacity of the battery. By using at least two temperature measuring sites, both the maximum temperature and the temperature gradients occurring in the battery cells are taken into consideration during regulation by means of a characteristic curve, which is dependent on the conditions of use and on battery parameters. In addition, one of several characteristic curves can be selected from a family of characteristic curves, wherein the various characteristic curves can reflect different conditions of use and battery parameters. This characteristic curve or this family of characteristic curves can be used to actuate a relay or regulating valve or a compressor or a pump as the regulating unit, which regulates the flow through the cooling channels of a cooling unit.

In this manner, threshold values for battery temperatures are maintained, while at the same time, temperature differences within the battery cells can be minimized.

Because aging and/or damage to cells caused by large temperature gradients with the cell can be greater than those caused by a moderate temperature increase, a maximization of battery lifespan can be achieved with this regulating strategy. In addition, the load peaks of battery waste heat do not lead to load peaks in the heat that is carried off, and therefore, the cooling system or the refrigerating circuit, and, if applicable, additional components connected thereto are also relieved. The presented regulating strategy for cooling high-performance batteries therefore leads to an increase in the battery lifespan over previously known solutions.

A further advantage is the possibility of raising the battery temperature in a controlled manner under heavy loads, which leads to a decrease in power losses and therefore to greater efficiency of the battery. Regulation can also be carried out in a simple manner, for example, in the battery management system, and requires only two temperature measuring sites. Greater processing power, as is required with regulating systems proposed in the prior art, for example, is not necessary. The following paragraphs describe practical embodiments and additional aspects of this regulating strategy.

Advantageously, in the selection step, the control variable can be selected on the basis of the temperature at the primary measuring site. The primary measuring site generally provides information regarding the instantaneous maximum temperature of the energy accumulator unit, and is relevant to the extent that a temperature that exceeds an upper threshold temperature would lead to damage to the energy accumulator unit. Knowledge of the maximum temperature of the energy accumulator cell offers the advantage that a precise determination can be made as to when cooling of the energy accumulator unit should be switched to full power, in order to prevent damage to the energy accumulator unit or, in the opposite case, should be switched off completely so that the efficiency of the energy accumulator unit does not decrease too much.

In one favorable embodiment of the invention, in the selection step, a duty factor of a pulse width modulated signal can be selected as the control variable, wherein in the actuation step, the regulating unit can be actuated with the pulse width modulated signal as the control variable. This offers the advantage of actuating the regulating unit such that it is adjusted precisely to cooling requirements, as said unit can be adjusted steplessly via the pulse width modulated signal. Nevertheless, a simple switch can be used in this case, which switches the cooling unit either on or off and requires no enabling of intermediate stages.

In a further favorable embodiment of the invention, in the selection step, the duty factor can be selected as the control variable within a temperature interval, using the characteristic curve, wherein in the selection step, a duty factor of zero can also be selected if the temperature at the primary measuring site is lower than a lower threshold temperature of the temperature interval, and wherein in the selection step, a duty factor of one can be selected if the temperature at the primary measuring site is greater than an upper threshold temperature of the temperature interval. In this manner, the capacity for a very rapid reaction time of the system for controlling the temperature of the energy accumulator unit in critical situations is provided, since, without computing or comparison effort, the cooling unit can either be switched to 0% power, in order to prevent the efficiency level from decreasing too far, or can be switched to 100% power, in order to prevent damage to the energy accumulator unit.

Advantageously, in the selection step, a duty factor can be selected which is greater, the higher the temperature is at the primary measuring site within the temperature interval.

It is thereby ensured that the maximum permissible temperature of the energy accumulator unit at which no irreversible damage thereof will occur is not reached.

In a further favorable embodiment of the method according to the invention, the selection step can be embodied in such a way that duty factors within the range of a maximum and a minimum duty factor, which are predefined within the temperature interval, cannot be selected. Therefore, a jump to the duty factor of 1 occurs from the maximum duty factor, and a jump to the duty factor of 0 occurs from a minimum duty factor. With these jumps, very rapid switching sequences of opening and closing the regulating unit can be avoided, thereby extending the lifespan thereof.

According to a further favorable embodiment of the invention, in the selection step, with a rising or falling temperature at the primary measuring site, predefined duty factors can be skipped, or a duty factor can be selected which does not exceed a maximum duty factor. Advantageously, by allowing a higher overall temperature of the energy accumulator unit, a thermal capacity thereof can thereby be utilized, and a development of overly high temperature differences in the energy accumulator unit can be prevented.

In one favorable embodiment of the invention, in the selection step, using the determined temperature difference, a characteristic curve can be selected from a family of predefined characteristic curves, wherein the control variable is selected using the selected characteristic curve. Because the characteristic curve is selected by means of a comparison operation between the determined temperature difference and a selection of predefined characteristic curves, the necessary computing effort can be reduced, and cost-intensive computing units can be dispensed with.

According to a further embodiment of the invention, in the selection step for a small temperature difference, a characteristic curve can be selected from the family of predefined characteristic curves which, with a predefined temperature at the primary measuring site, results in a large control variable, and in the selection step for a large temperature difference, a characteristic curve can be selected from the family of predefined characteristic curves which, at the predefined temperature at the primary measuring site, results in a small control variable. In the case of small temperature differences, by selecting a suitable characteristic curve from the family of predefined characteristic curves, the battery temperature inside the battery cells can be held at the lower limit of the allowable temperature window by means of cooling. Advantageously, the aging of the battery cells or of the energy accumulator unit, which is accelerated as the battery temperature increases, can thereby be held to a minimum. If the temperature difference inside the battery cells increases due to a greater load and the resulting initially greater dissipation of heat, a characteristic curve can be selected from the family of predefined characteristic curves which effects a regulation with which a higher battery temperature is allowed within the permitted temperature window. The load peaks occurring during normal operation can therefore be taken up by the thermal capacity of the battery or a uniform temperature increase, resulting in no or only a limited increase in the temperature difference within the battery cells. Also advantageous in this case is the significantly reduced development of heat in the battery cells at a higher temperature, which can also contribute to reducing the temperature gradients within the cells.

In a further favorable embodiment of the method according to the invention, in the selection step a period of a pulse width modulated signal can be selected as the control variable, wherein in the actuation step, the control element can be actuated using the pulse width modulated signal as the control variable. In this case, the period can be used as the sole control variable or in combination with the duty factor of the pulse width modulated signal as the control variable.

Advantageously, in the selection step, the period can be selected as the control variable on the basis of the change over time of the temperature difference, wherein the period can be selected such that an increase in the change over time causes a decrease in the period, and a decrease in the change over time causes an increase in the period. Such an embodiment of the invention offers the advantage that by adjusting the period, a rapid reaction time to a temperature change is possible. For example, if the temperature difference changes rapidly, the period should be short, so that a rapid reaction to the increased temperature difference is ensured. If, however, the temperature difference changes only slowly, a longer period can also be selected, since the creation and/or dissipation of heat can be accurately calculated over a longer observation period.

A further advantage of the method according to the invention can be achieved in that in the selection step, prior to determining the change over time in the temperature difference, a low pass filtration of the temperature difference is conducted. Such an embodiment of the invention offers the advantage that short-term fluctuations in the temperature difference do not lead to a rapid regulation of the cooling unit, and therefore, the regulation of the cooling unit remains stable overall.

According to a further embodiment of the invention, in the selection step, a switch-on temperature can be determined as the control variable, dependent on the temperature difference, wherein in the actuation step, the control variable is actuated in such a way that cooling and/or refrigerating agent can flow through the cooling unit if the temperature at the primary measuring site lies above the switch-on temperature, or in the selection step, a switch-off temperature can be determined as the control variable, dependent upon the temperature difference, wherein in the actuation step, the control variable is actuated in such a way that the flow through the cooling unit is prevented when the temperature at the primary measuring site is lower than the switch-off temperature. The advantage of such an expanded 2-point regulation lies in a simple implementation that is less susceptible to failure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a system for regulating a temperature of an energy accumulator unit using one embodiment example of the present invention;

FIG. 2 is a representation of a family of characteristic curves used in one embodiment example of the invention;

FIG. 3 is a representation of a family of characteristic curves used in a further embodiment example of the invention;

FIG. 4 is a representation of a family of characteristic curves used in one embodiment example of the invention;

FIG. 5 is a representation of a family of characteristic curves used in a further embodiment example of the invention;

FIG. 6 is a representation of a characteristic curve used in a further embodiment example of the invention;

FIG. 7 is a representation of a characteristic curve used in a further embodiment example of the invention;

FIG. 8 is a further block diagram of one embodiment example of a system for regulating a temperature of an energy accumulator unit using an embodiment example of the present invention; and

FIG. 9 is a flow chart of an embodiment example of the invention as a method.

### DETAILED DESCRIPTION

In the following drawings, identical or similar elements can be furnished with identical or similar reference signs, wherein a repeated description of these elements is dispensed with. Any subsequently provided measurements and dimensions are intended merely to clarify the invention, and are not intended as a restriction of the invention to these measurements and dimensions. Furthermore, the figures in the drawings, the descriptions thereof, and the claims contain numerous features in combination. It will be clear to a person skilled in the art that these features can also be considered individually, or can be combined to form combinations not explicitly described here.

Specifically, for battery cooling or for cooling the energy accumulator unit, thermal contact should be provided between the battery cells and at least one cooling unit that conducts cooling medium.

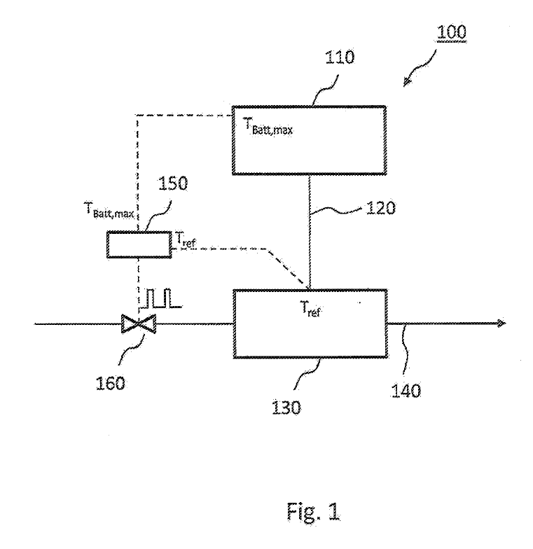

FIG. 1 shows a block diagram of one embodiment example of the invention in a system 100 for regulating the temperature of an energy accumulator unit or battery cell 110, which has a maximum cell temperature T_{batt,max} at a primary measuring site, for example, and has a reference temperature T_{ref} at a secondary measuring site or a connection site, wherein the battery cell 110 is coupled via a thermal cell connection 120 to a cooling unit 130. A cooling medium 140 enters the cooling unit 130 and exits the same. The values Tₘₐₓ and T_{ref} are supplied to a regulating unit 150, where they are subjected to a differential calculation, for example. A result of this differential calculation can then be used for actuating a control element (e.g., a valve) 160 for regulating the mass flow rate of cooling medium 140 through the cooling unit 130, wherein the control element 160 can be embodied as a timing valve.

Alternatively, additional throttling points and/or valves and/or distribution points for distributing the flow can be provided between the timing valve and the channels of the cooling unit 130 for conducting cooling medium.

The functioning of the timing valve 160 can be controlled via a pulse width modulated signal. In this case, both the period and the duty factor of the pulse width modulated signal serve as control variables. The duty factor indicates the percentage of a period during which the timing valve is opened. With a duty factor of 0, therefore, the timing valve is constantly closed, whereas with a value of 1, it is constantly open.

The maximum cell temperature in the cell stack or inside the energy accumulator unit T_{batt,max} and the temperature at the connection site of these cells T_{ref} are preferably used as control variables. In what follows, the difference between T_{batt,max} and T_{ref} will be referred to as the temperature spread or temperature difference ΔT and is approximately proportional to the temperature gradient within the battery cell. As long as the temperature T_{batt,max} lies below a lower threshold temperature T₁, the duty factor is set to 0, and no cooling medium flows through the cooling unit 130. If the temperature T_{batt,max} is greater than an upper threshold temperature T₂, the duty factor is set to 1, in order to ensure the fastest possible cooling of the battery.

For the temperature interval T₁<T_{batt,max}<T₂, a family of characteristic curves for the duty factor is stored which will lead to a minimization of the temperature spread or temperature difference ΔT within a cell. This family of characteristic curves is dependent upon the field of use (hybrid automobile, electric vehicle, off-highway application) and the structure of the battery, for example, and upon the battery type. Influencing variables include the cell geometry, the conduction of heat within the cells and between the cells, the configuration of the cell connection, the temperature of the cooling medium, and the permissible temperature spread in the cells and in the entire battery stack.

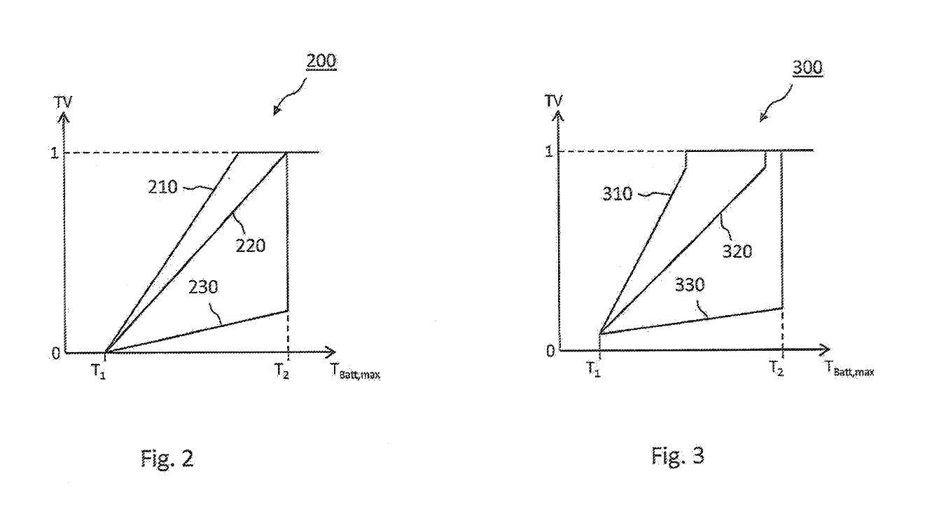

FIG. 2 shows a graphic representation of a family of characteristic curves in a system of coordinates 200 used in one embodiment example.

In the system of coordinates 200, a temperature at a primary measuring site of the energy accumulator unit T_{batt,max} is plotted on the abscissa, wherein T₁ represents the lower threshold temperature of T_{batt,max} and T₂ represents the upper threshold temperature of T_{batt,max}. A duty factor TV of the pulse width modulated signal via which the timing valve is opened and/or closed is plotted on the ordinate, wherein at the value 0 the timing valve is closed over the entire period of the signal, and at a value of 1 the timing valve is opened over the entire period. A family of characteristic curves is composed of characteristic curves 210, 220, 230, which have, for example, a common point of intersection at T_{batt,max}=T₁ and a duty factor TV of 0. The first characteristic curve 210 in this case is a characteristic curve for a small temperature difference ΔT=small, the second characteristic curve 220 is a characteristic curve for a moderate temperature difference ΔT=moderate, and the third characteristic curve 230 is a characteristic curve for a large temperature difference ΔT=large. The family of characteristic curves can also have more or fewer characteristic curves than are shown in FIG. 2.

Characteristic is a rising straight-line slope of the characteristic curves 210, 220, 230 with a falling temperature spread ΔT. The family of characteristic curves is structured in such a way that with an average load on the battery and a temperature spread ΔT=moderate, the heat flow is dissipated, which results as dissipated heat in the battery. As the load increases, the battery temperature T_{batt,max} increases, which would lead to an increase in the duty factor TV. However, because the temperature spread ΔT also increases at the same time, the family of characteristic curves shifts to the curve 230 having the shallower slope, and the duty factor TV does not increase, or increases only slightly. Ultimately, this causes the cell temperature T_{batt,max} to increase, but the temperature spread ΔT increases only slightly. As soon as the load cycle of the battery leads back to a lower power loss, the temperature spread ΔT decreases automatically, and the family of characteristic curves shifts to the curve 220 having a steeper slope. The duty factor TV is thereby increased, and the battery is cooled back to the normal operating temperature at a moderate load. When the maximum temperature T_{batt,max}>T₂ is exceeded, the duty factor TV is set to 1, in order to drop the temperature back below the upper threshold temperature T₂ as quickly as possible. As soon as it has dropped below this threshold, the family of characteristic curves is again used for regulation. When the temperature drops below the maximum temperature T_{batt,max}<T₁ the duty factor TV is set to 0, and therefore, the efficiency of the energy accumulator unit does not decrease too radically.

In a second embodiment example of the present invention, the family of characteristic curves is embodied according to FIG. 3, which represents a modification of the family of characteristic curves represented in FIG. 2. FIG. 3 shows a system of coordinates 300 similar to the system shown in FIG. 2, in which again the values for the temperature T_{batt,max} at the primary measuring site of the energy accumulator unit are plotted on the abscissa, and the values for the duty factor TV of the pulse width modulated signal are plotted on the ordinate between 0 and 1. Once again, a family of characteristic curves is composed of a group of curves 310, 320, 330, wherein in this case as well, the family of characteristic curves can have more or fewer characteristic curves than are shown in FIG. 3. The first characteristic curve 310 represents a small temperature difference ΔT=small, the second characteristic curve 320 represents a moderate temperature difference ΔT=moderate, and the third characteristic curve 330 represents a temperature difference ΔT=large. In contrast to the graphic representation of FIG. 2, however, a common point of intersection of the characteristic curves 310, 320, 330 for the temperature T₁ occurs at a minimum duty factor TV. Similarly, as the duty factor TV approaches a constant opening, the value jumps to 1. These jumps prevent very rapid switching sequences between opening and closing of the timing valve, and therefore can increase its lifespan.

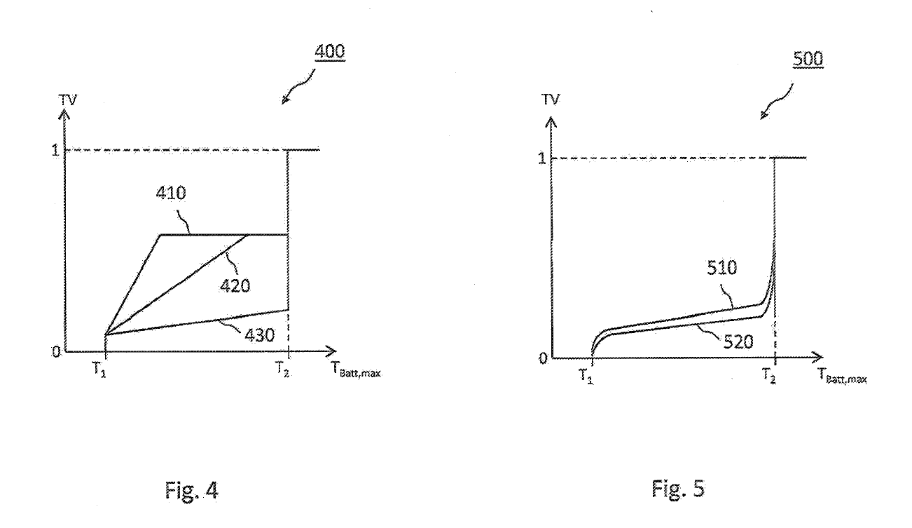

FIG. 4 shows a further variant of the temperature regulation, also using a family of characteristic curves. Depicted is a system of coordinates 400, which is structured similarly to the systems of coordinates of FIGS. 2 and 3. Once again, the maximum temperature T_{batt,max} at the primary measuring site of the energy accumulator unit is plotted on the abscissa, and the duty factor TV of the timing valve is plotted on the ordinate. Here again, the system of coordinates comprises a family of characteristic curves 410, 420, 430, wherein more or fewer characteristic curves than the characteristic curves 410, 420, 430 that are shown may be used. The first characteristic curve 410 again represents a small temperature difference ΔT=small, the second characteristic curve 420 represents a moderate temperature difference ΔT=moderate, and the third characteristic curve 430 represents a large temperature difference ΔT=large. The family of characteristic curves as shown in FIG. 3 is characterized in that a common point of intersection of the characteristic curves 410, 420, 430 for a lower threshold temperature T₁ at the primary measuring site is set to a minimum duty factor TV. The embodiment example of the approach according to the invention specified in the graphic representation of FIG. 4 differs from the embodiment example shown in FIG. 3 in that, when a predefined duty factor TV at T_{batt,max}<T₂ is reached, this duty factor is maintained up to the upper threshold temperature T₂. This serves to prevent unduly large temperature spreads ΔT in the cells. For extreme cases, such as a very hot battery during start-up or a very high load on the battery (e.g., with a rapid charge), however, greater cooling power is available as a result of a complete and longer-lasting opening of the valve.

The linear characteristic curves represented in the variants according to FIGS. 2 to 4 can also be replaced by curves of any shape or mathematical functions. FIG. 5 shows a system of coordinates 500, which is structured similarly to the systems of coordinates of FIGS. 2 to 4. However, in FIG. 5, an example of the shape of two characteristic curves 510 and 520 is plotted, wherein a first characteristic curve 510 represents a small temperature difference ΔT and a second characteristic curve 520 represents a large temperature difference ΔT. However, more or fewer characteristic curves than are represented in FIG. 5 may also be used. In addition, families of characteristic curves are conceivable, in which the characteristic curves have no shared point of intersection, however, this is not shown in the attached set of figures.

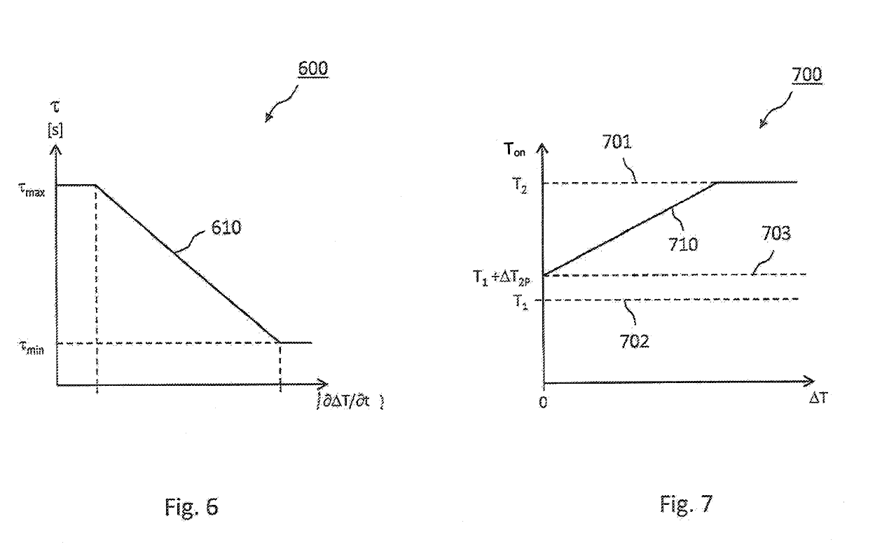

As an additional control variable, a period τ of the pulse width modulated signal can be used. A corresponding embodiment example of this approach is shown in FIG. 6. In a system of coordinates 600, a change in the temperature spread over time |∂ΔT/∂t| is plotted on the abscissa. The period of the pulse width modulated signal is plotted on the ordinate, wherein the period according to the embodiment example shown in FIG. 6 can be adjusted on the basis of a characteristic curve 610 between a minimum value τₘᵢₙ and a maximum value τₘₐₓ. The minimum and maximum periods τₘᵢₙ and τₘₐₓ are to be established separately for each battery, for example. The period τ should not be selected as too small, in order to prevent very frequent switching processes in the timing valve 160, which can lead to a significant reduction in the lifespan of the valve. On the other hand, with overly large periods τ, effective regulation cannot be ensured. As the regulating parameter for the period τ, a change in the temperature spread over time |∂ΔT/∂t| can be used. With a very large change in the temperature spread over time (|∂ΔT/∂t| large), the period must be reduced. In contrast, with a very small change over time (|∂ΔT/∂t| small), the period must be increased. This is therefore expressed by a falling slope in the characteristic curve 610. To calculate the change in the temperature spread ΔT over time, a low pass filtering of the temperature spread ΔT can be conducted in advance.

An alternative embodiment of the approach according to the invention for regulating by means of a pulse width modulated timing valve relates to an expanded 2-point regulation via a switchable valve, as is illustrated in FIG. 7. FIG. 7 is a representation of a characteristic curve in a system of coordinates 700, wherein in this system of coordinates, a temperature difference ΔT is plotted on the abscissa. A switch-on temperature Tₒₙ at which an opening of the timing valve 160 is actuated is plotted on the ordinate. Two temperature values T₁ and T₂ which lie on the ordinate form the threshold values for a permissible or desirable temperature window T₁ . . . T₂, which is illustrated by two dashed lines 701 and 702 running parallel to the abscissa. The position of an additional dashed line 703 that runs parallel to the abscissa is determined by a temperature value T₁+ΔT_{2P}, wherein the line 703 is located within the temperature window T₁ . . . T₂. In this, a characteristic curve 710 preferably extends within the temperature window T₁ . . . T₂ between the lines 703 and 701.

In this embodiment example, the valve 160 is opened as soon as the battery temperature T_{batt,max} exceeds a critical value Tₒₙ, and is closed as soon as it drops below a critical value T_{off}=Tₒₙ−ΔT_{2P}. The two values Tₒₙ and T_{off} should be held within the temperature window T₁ . . . T₂. To obtain a regulation behavior similar to the above-described pulse width modulation, Tₒₙ is established using the characteristic curve 710, again on the basis of the temperature spread ΔT. In this, Tₒₙ behaves inversely to the duty factor TV, and, in the case of a large temperature spread ΔT, increases, in order to temporarily raise the battery temperature accordingly. The change over time of ΔT can additionally be taken into consideration by adjusting the temperature difference between the switch-on and switch-off temperatures Tₒₙ and ΔT_{2P}.

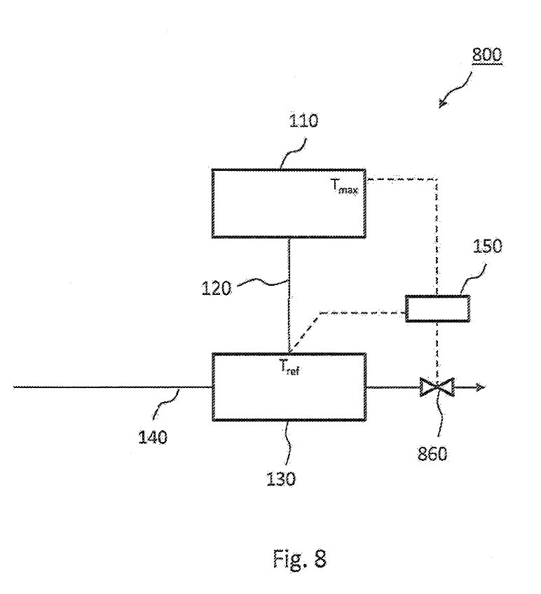

Alternatively to the timing or relay valve 160 situated upstream of the cooling unit, a back pressure valve for refrigerating agent, situated downstream of the cooling unit, can be used. FIG. 8 shows a block diagram of an additional embodiment example of a system for regulating a temperature of an energy accumulator unit using a back pressure valve of this type. The elements of a system 800 shown in FIG. 8 and the interrelationships thereof are understood similarly to the elements shown in FIG. 1, with the difference that a valve 860 is embodied as a back pressure valve and is situated downstream of the cooling unit 130. Similarly to a regulation via the duty factor TV using the timing valve, with back pressure regulation the valve position is regulated between closed (0) and fully opened (1). By adjusting the back pressure, the vapor pressure or the evaporation temperature is regulated, and therefore, the heat to be dissipated is influenced.

The mass flow of cooling medium can alternatively be adjusted by means of a controllable pump. By using a refrigerating circuit with refrigerating agent, adjustment of the back pressure via a controllable compressor is also conceivable. Similarly to the process of regulating via the duty factor using the timing valve, the pump or compressor flow volume is regulated between zero (0) and the maximum flow volume (1). This is preferably accomplished by adjusting the speed between zero (0) and the maximum speed (1). This alternative embodiment example for regulating a temperature of an energy accumulator unit is not shown in the drawings.

For calculating the temperature spread ΔT, other characteristic temperatures may also be used in place of the maximum cell temperature Tₘₐₓ and the plate temperature T_{ref} as reference temperatures. It is also conceivable to attach measuring sites on several battery cells within the cell stack, in order then to use the cell having the highest temperature Tₘₐₓ or the greatest temperature spread ΔT for regulation.

Overall, using the illustrated embodiment examples, a dynamic adjustment of the cell temperature to the temperature differences occurring in the cells, or a selective utilization of the thermal capacity of the battery cells is achieved.

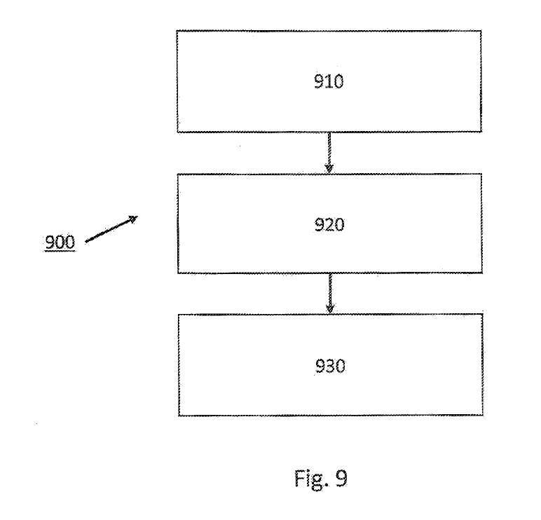

FIG. 9 shows a flow chart of an embodiment example of the present invention as method 900 for regulating a temperature of an energy accumulator unit, wherein the energy accumulator unit is in thermal contact with a cooling unit through which a cooling and/or refrigerating agent flows. The method comprises a step of determining (910) a temperature difference between a temperature at a primary measuring site of the energy accumulator unit and a temperature at a secondary measuring site of the energy accumulator unit or the cooling unit. The method (900) further comprises a step of selecting (920) a control variable using the determined temperature difference and a predefined, wherein the predefined characteristic curve represents a correlation between a control variable and a temperature difference or a variable that is dependent thereon. Finally, the method (900) comprises a step of actuating (930) a control element by means of a regulating unit, using the selected control variable, in order to regulate a flow of the cooling and/or refrigerating agent through the cooling unit, in order to thereby regulate the temperature of the energy accumulator unit.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for regulating a temperature of an energy accumulator unit, wherein the energy accumulator unit is in thermal contact with at least one cooling unit through which a cooling and/or refrigerating agent flows, the method comprising:
determining a temperature difference between a temperature at a primary measuring site of the energy accumulator unit and a temperature at a secondary measuring site of the energy accumulator unit or the cooling unit;
selecting a control variable using the determined temperature difference and a predefined characteristic curve or mathematical function, the predefined characteristic curve representing a correlation between a control variable and a temperature difference or a variable that is dependent thereon; and
actuating a control element via a regulator unit using the selected control variable, in order to regulate the flow of cooling and/or refrigerating agent through the cooling unit and thereby regulating the temperature of the energy accumulator unit.

2. The method according to claim 1, wherein, in the selection step, the control variable is also selected on the basis of the temperature at the primary measuring site.

3. The method according to claim 1, wherein, in the selection step, a duty factor of a pulse width modulated signal is selected in the regulating unit as a control variable, and wherein in the actuation step, the control element is actuated using the pulse width modulated signal as the control variable.

4. The method according to claim 2, wherein, in the selection step, the duty factor is selected as the control variable within a temperature interval using the characteristic curve, wherein, in the selection step, a duty factor of zero is selected when the temperature at the primary measuring site is lower than a lower threshold temperature of the temperature interval, and wherein, in the selection step, a duty factor of one is selected when the temperature at the primary measuring site is greater than an upper threshold temperature of the temperature interval.

5. The method according to claim 4, wherein, in the selection step, a duty factor is selected which is greater, the higher the temperature is at the primary measuring site within the temperature interval.

6. The method according to claim 4, wherein the selection step is embodied such that predetermined duty factors within the temperature interval in the range of a maximum and a minimum duty factor cannot be selected.

7. The method according to claim 4, wherein, in the selection step, with an increasing or decreasing temperature at the primary measuring site, predefined duty factors are skipped, or a duty factor that does not exceed a maximum duty factor is selected.

8. The method according to claim 1, wherein, in the selection step, using the determined temperature difference, a characteristic curve is selected from a family of predefined characteristic curves, and wherein the control variable is selected using the selected characteristic curve.

9. The method according to claim 8, wherein, in the selection step, for a small temperature difference, a characteristic curve from the family of predefined characteristic curves is selected, which, at a predefined temperature at the primary measuring site, results in a large control variable, and wherein, in the selection step for a large temperature difference, a characteristic curve (from the family of predefined characteristic curves is selected, which at the predefined temperature at the primary measuring site results in a small control variable.

10. The method according to claim 1, wherein, in the selection step, a period of a pulse width modulated signal is selected as the control variable, and wherein in the actuation step, the control element is actuated with the pulse width modulated signal as the control variable.

11. The method according to claim 10, wherein, in the selection step, the period is selected as the control variable on the basis of the change over time in the temperature difference, wherein the period is selected such that an increase in the amount of change over time causes a decrease in the period, and a decrease in the amount of change over time causes an increase in the period.

12. The method according to claim 10, wherein, in the selection step, before determining the change over time in the temperature difference, a low pass filtering of the temperature difference is conducted.

13. The method according to claim 1, wherein, in the selection step, a switch-on temperature is determined as the control variable on the basis of the temperature difference, wherein in the actuation step, the regulating unit causes cooling and/or refrigerating agent to flow through the cooling unit when the temperature at the primary measuring site lies above the switch-on temperature and/or wherein in the selection step, a switch-off temperature is determined as the control variable on the basis of the temperature difference, wherein in the actuation step, the control element is actuated such that cooling and/or refrigerating agent is prevented from flowing through the cooling unit when the temperature at the primary measuring site is lower than the switch-off temperature.

14. A regulating device, which is embodied for carrying out and/or actuating the steps of the method according to claim 1.

15. A computer program having a program code for carrying out and/or actuating the steps of the method according to claim 1, when the computer program is executed in a control device or a data processing system.
